(19) United States
(12) Patent Application Publication
(10) Pub. No.: US 2005/0119679 A1
(43) Pub. Date: Jun. 2, 2005

(54) Apparatus and method for an ultrasonic medical device to treat chronic total occlusions

(75) Inventors: Robert A. Rabiner, North Reading, MA (US); Bradley A. Hare, Chelmsford, MA (US)

Correspondence Address: PALMER & DODGE, LLP;RICHARD B. SMITH, 111 HUNTINGTON AVENUE, BOSTON, MA, 02199, US

(73) Assignee: OmniSonics Medical Technologies, Inc.

(21) Appl. No.: 10/976,267

(22) Filed: Oct. 28, 2004

Related U.S. Application Data
(63) Continuation-in-part of application No. 10/665,445, filed on Sep. 19, 2003.
Application No. 10/665,445 is a continuation of application No. 09/776,015, filed on Feb. 2, 2001, now Pat. No. 6,652,547.
Application No. 09/776,015 is a continuation-in-part of application No. 09/618,352, filed on Jul. 19, 2000, now Pat. No. 6,551,337.
(60) Provisional application No. 60/178,901, filed on Jan. 28, 2000.
(60) Provisional application No. 60/157,824, filed on Oct. 5, 1999.

(51) Int. Cl. A61D 1/02

(52) U.S. Cl. 606/159; 606/169

(57) ABSTRACT

An apparatus and method for using an ultrasonic medical device to treat chronic total occlusions comprises an ultrasonic probe, a transducer, a coupling engaging a proximal end of the ultrasonic probe to a distal end of the transducer and an ultrasonic energy source engaged to the transducer. The ultrasonic probe is inserted into a vasculature and placed in communication with the chronic total occlusion. The ultrasonic energy source produces an ultrasonic energy that is transmitted to the transducer, where the transducer creates a transverse ultrasonic vibration along the ultrasonic probe. The transverse ultrasonic vibration creates a plurality of transverse nodes and a plurality of transverse anti-nodes along the longitudinal axis of the ultrasonic probe, creating cavitation along a portion of the longitudinal axis of the ultrasonic probe to ablate the chronic total occlusion.

### RELATED APPLICATIONS

This application is a continuation-in-part of application Ser. No. 10/665,445, filed Sep. 19, 2003, which is a continuation of application Ser. No. 09/776,015, filed Feb. 2, 2001, now U.S. Pat. No. 6,652,547, which is a continuation-in-part of application Ser. No. 09/618,352, filed Jul. 19, 2000, now U.S. Pat. No. 6,551,337, which claims benefit of Provisional Application Ser. No. 60/178,901, filed Jan. 28, 2000, and claims benefit of Provisional Application Ser. No. 60/157,824, filed Oct. 5, 1999, the entirety of all these applications are hereby incorporated herein by reference.

### FIELD OF THE INVENTION

The present invention relates to medical devices, and more importantly to an apparatus and a method for an ultrasonic medical device to treat chronic total occlusions.

### BACKGROUND OF THE INVENTION

A chronic total occlusion in a vasculature of a body has life threatening effects for a patient. A chronic total occlusion is a condition in which the occluding material substantially blocks the cross section of the vasculature over a length of the vasculature. The chronic total occlusion substantially stops blood flow through the vasculature and can result in oxygen deprivation to the tissue near the occlusion. Chronic total occlusions can occur throughout the venous and arterial systems of the vasculature. Particulate from the chronic total occlusion can cause further complications downstream of the site of the occlusion.

A chronic total occlusion is a leading contributor of various vascular occlusive diseases, including but not limited to, cardiovascular disease, peripheral vascular disease, peripheral artery diesease and artherosclerosis. Effects of a chronic total occlusion include discomfort, chest pain and, in some cases, death.

Cardiovascular disease includes dysfunctional conditions of the heart, arteries, and veins that supply oxygen to vital life-sustaining areas of the body like the brain, the heart itself, and other vital organs. If oxygen does not arrive, the tissue or organ will die. Common forms of cardiovascular disease include, heart disease and stroke, the first and third leading causes of death for both men and women in the United States, accounting for approximately forty percent of all deaths. About sixty-one million Americans have some form of cardiovascular disease, with about 650,000 Americans dying of cardiovascular disease each year. Both arteriosclerosis (calcium deposits) and atherosclerosis (fat deposits) involve a buildup on the inside of artery walls. Atherosclerosis, a condition in which deposits of plaque (fatty substances, cholesterol, cellular waste products, calcium and other substances) build up in the inner lining of an artery, is a leading source of cardiovascular disease.

Peripheral vascular disease is a form of atherosclerosis referring to narrowing of blood vessels outside of the heart and the brain, and often a narrowing of vessels that carry blood to the leg and the arm muscles. Peripheral artery disease is a condition similar to coronary artery disease and carotid artery disease, in which fatty deposits build up along artery walls mainly in the legs and feet and affect blood circulation.

The presence of a chronic total occlusion in a vasculature of a body presents a challenge to the medical professional. In some cases, the medical professional will choose to perform a bypass procedure due to the nature of the chronic total occlusion. In other cases, the challenge to the medical professional lies in passing a device through the total occlusion without sacrificing the structure of the vasculature and the health and safety of the patient. In many cases, the blockage of the vasculature and subsequent oxygen deprivation to adjacent tissue necessitates traversing the total occlusion in a short time frame.

U.S. Pat. No. 6,579,302 to Duerig et al. discloses a guidewire comprising a spreader, a flexible wire and a core wire. After inserting the Duerig et al. guidewire device into the lumen of the occluded vessel and proximal to the occlusion, the spreader and a flexible wire are advanced over a core wire until the spreader is in an open position with its largest diameter. The Duerig et al. device is moved in a ratcheting fashion through the occlusion to open the occlusion with the spreader. The Duerig et al. device must be pushed through the occlusion and only partially opens the cross section of the occluded vessel. Because the Duerig et al. device does not destroy the occlusion, particulate from the occlusion can travel downstream of the site of the occlusion and result in other health complications. In addition, the large diameter of the spreader in the open position could compromise the integrity of the vessel.

U.S. Pat. No. 6,235,000 to Milo et al. discloses an apparatus for crossing a total occlusion in a blood vessel. The Milo et al. device includes a guidewire and a deflecting catheter having a mechanism for laterally deflecting the guidewire to an approximate center of the blood vessel. The Milo et al. guidewire is advanced through the blood vessel and into the subintimal space within the medial layer and the defecting catheter is advanced over the guidewire until its distal tip extends beyond the total occlusion. The Milo et al. guidewire is advanced through a mechanism such as a lateral port to laterally deflect the wire so it passes back in a radially inward direction through the intimal layer and into the blood vessel lumen. The Milo et al. device imparts high stresses on the intimal and medial layers of the blood vessel and must be combined with a catheter-based procedure. The Milo et al. device does not ablate the occlusion and particulate broken off from the advancement of the Milo et al. device through the occlusion could travel downstream of the site of the occlusion and cause subsequent health complications.

U.S. Pat. No. 5,304,199 to Myers discloses an apparatus for arterial total occlusion plaque separation. The Myers device includes a guiding catheter, a guidewire and a balloon catheter. The Myers guidewire is inserted into the artery, the guiding catheter is positioned over the guidewire and advanced up to the ostium of the occluded artery, and a balloon catheter and a percutaneous transluminal coronary angioplasty (PTCA) wire are advanced through the guiding catheter and placed proximal to the total occlusion. The PTCA wire is passed through the total occlusion after the balloon is inflated and a plaque cleft is formed, leaving the PTCA wire across the newly developed cleft in position for a subsequent conventional angioplasty. The Myers device does not destroy the occlusion and is used to pass through the occlusion to allow a conventional angioplasty procedure to be performed. Particulate broken off from the inflation of the balloon and passing of the PTCA wire through the total occlusion presents further health complications downstream of the site of the occlusion.

Prior art devices and methods do not solve the problem of safely removing a chronic total occlusion in a time efficient manner. Prior art devices impart high stresses on the vasculature, must be forced through the chronic total occlusion and require subsequent catheter-based procedures which further compromises the integrity of the vasculature. Therefore, there remains a need in the art for an apparatus and a method of treating a chronic total occlusion that removes the total occlusion in a time efficient manner.

### SUMMARY OF THE INVENTION

An apparatus and method for using an ultrasonic medical device to treat chronic total occlusions comprises an ultrasonic probe, a transducer, a coupling engaging a proximal end of the ultrasonic probe to a distal end of the transducer and an ultrasonic energy source engaged to the transducer. The ultrasonic probe is inserted into a vasculature and placed in communication with the chronic total occlusion. The ultrasonic energy source produces an ultrasonic energy that is transmitted to the transducer, where the transducer creates a transverse ultrasonic vibration along the ultrasonic probe. The transverse ultrasonic vibration creates a plurality of transverse nodes and a plurality of transverse anti-nodes along the longitudinal axis of the ultrasonic probe, creating cavitation along a portion of the longitudinal axis of the ultrasonic probe to ablate the chronic total occlusion.

An ultrasonic medical device for ablating a chronic total occlusion comprises an ultrasonic probe having a proximal end, a distal end and a longitudinal axis therebetween; an ultrasonic energy source for producing an ultrasonic energy; a transducer engaged to the ultrasonic energy source for transferring the ultrasonic energy; and a coupling engaged to the transducer and the proximal end of the ultrasonic probe, wherein a transverse ultrasonic vibration of the ultrasonic probe maneuvers the ultrasonic probe through the chronic total occlusion.

An ultrasonic medical device for treating a chronic total occlusion comprises an ultrasonic probe having a proximal end, a distal end terminating in a probe tip and a longitudinal axis between the proximal end and the distal end, the ultrasonic probe having a flexibility to be flexed through the vasculature and the chronic total occlusion; a transducer creating a transverse ultrasonic vibration along at least a portion of the longitudinal axis of the ultrasonic probe; a coupling engaging the proximal end of the ultrasonic probe to a distal end of the transducer; and an ultrasonic energy source engaged to the transducer that produces an ultrasonic energy, wherein the transverse ultrasonic vibration produces a plurality of transverse anti-nodes along a portion of the longitudinal axis of the ultrasonic probe to treat the chronic total occlusion.

The present invention also provides a method of ablating a chronic total occlusion comprising: providing an ultrasonic medical device comprising an ultrasonic probe having a proximal end, a distal end and a longitudinal axis therebetween; inserting the ultrasonic probe into a vasculature; moving the ultrasonic probe adjacent to the chronic total occlusion; activating an ultrasonic energy source engaged to the ultrasonic probe to generate a transverse ultrasonic vibration along at least a portion of the longitudinal axis of the ultrasonic probe, and placing the ultrasonic probe in communication with the chronic total occlusion; wherein the transverse ultrasonic vibration of the ultrasonic probe creates an acoustic pressure surrounding the ultrasonic probe to ablate the chronic total occlusion and create a channel through the total chronic occlusion.

The present invention also provides a method of removing a chronic total occlusion in a vasculature of a body comprising: providing an ultrasonic medical device comprising an ultrasonic probe having a proximal end, a distal end terminating in a probe tip, and a longitudinal axis between the proximal end and the distal end; inserting the ultrasonic probe in the vasculature; moving the ultrasonic probe adjacent to the chronic total occlusion; activating an ultrasonic energy source engaged to the ultrasonic probe to produce an electric signal that drives a transducer of the ultrasonic medical device to produce a transverse ultrasonic vibration of the ultrasonic probe; advancing the ultrasonic probe through the chronic total occlusion, wherein the transverse ultrasonic vibration produces cavitation in a medium surrounding the ultrasonic probe to ablate the chronic total occlusion along a portion of the longitudinal axis of the ultrasonic probe.

The present invention provides an apparatus and a method for an ultrasonic medical device to treat chronic total occlusions. An ultrasonic probe is placed in communication with a chronic total occlusion and a transverse ultrasonic vibration along at least a portion of the longitudinal axis of the ultrasonic probe ablates the chronic total occlusion. The present invention provides an ultrasonic medical device for treating chronic total occlusions that is simple, user-friendly, time efficient, reliable and cost effective.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 is a side plan view of an ultrasonic probe of the present invention inserted into a vasculature adjacent to a chronic total occlusion.

FIG. 2 is a side plan view of an ultrasonic probe of the present invention capable of ablating a chronic total occlusion.

FIG. 3 is a side plan view of an embodiment of an ultrasonic probe of the present invention capable of ablating a chronic total occlusion where a diameter of the ultrasonic probe is approximately uniform from the proximal end of the ultrasonic probe to the distal end of the ultrasonic probe.

FIG. 4 is a side plan view of an ultrasonic probe of the present invention showing a plurality of transverse nodes and a plurality of transverse anti-nodes along a portion of a longitudinal axis of the ultrasonic probe for ablating a chronic total occlusion.

FIG. 5 is a view of an ultrasonic probe of the present invention adjacent to the chronic total occlusion in a coronary artery of a heart.

FIG. 6 is an enlarged view of a chronic total occlusion in a vasculature of a body.

FIG. 7 is a view of an ultrasonic probe of the present invention showing a plurality of transverse nodes and a plurality of transverse anti-nodes in communication with a chronic total occlusion.

FIG. 8 is a view of the ultrasonic probe of the present invention advanced over a length of the chronic total occlusion, creating a channel through the chronic total occlusion.

FIG. 9 is a view of an ultrasonic probe of the present invention in a vasculature after a chronic total occlusion has been ablated.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and spirit of the principles of the present invention.

### DETAILED DESCRIPTION

The present invention provides an apparatus and a method for using an ultrasonic medical device to treat chronic total occlusions. The ultrasonic medical device comprises an ultrasonic probe, a transducer, a coupling engaging a proximal end of the ultrasonic probe to a distal end of the transducer and an ultrasonic energy source engaged to the transducer. The ultrasonic probe is inserted into a vasculature and placed in communication with the chronic total occlusion. The ultrasonic probe comprises a flexibility to allow the ultrasonic probe to be bent, deflected and flexed in the vasculature without compromising the integrity of the vasculature or the ultrasonic probe. The ultrasonic energy source produces an ultrasonic energy that is transmitted to the transducer, where the transducer creates a transverse ultrasonic vibration along the ultrasonic probe. The transverse ultrasonic vibration creates a plurality of transverse nodes and a plurality of transverse anti-nodes along the longitudinal axis of the ultrasonic probe, creating cavitation along a portion of the longitudinal axis of the ultrasonic probe to ablate the chronic total occlusion.

The following terms and definitions are used herein:

“Ablate” as used herein refers to removing, clearing, destroying or taking away a chronic total occlusion. “Ablation” as used herein refers to a removal, clearance, destruction, or taking away of the chronic total occlusion.

“Anti-node” as used herein refers to a region of a maximum energy emitted by an ultrasonic probe at or adjacent to a specific location along a longitudinal axis of the ultrasonic probe.

“Node” as used herein refers to a region of a minimum energy emitted by an ultrasonic probe at or adjacent to a specific location along a longitudinal axis of the ultrasonic probe.

“Probe” as used herein refers to a device capable of propagating an energy emitted by the ultrasonic energy source along a longitudinal axis of the probe, resolving the energy into an effective cavitational energy at a specific resonance (defined by a plurality of nodes and a plurality of anti-nodes along an “active area” of the probe).

“Chronic Total Occlusion” as used herein refers to a collection of a matter including, but not limited to, a group of similar cells, intravascular blood clots, thrombus, plaque, fibrocalcific plaque, biological material, fibrin, calcified plaque, calcium deposits, occlusional deposits, atherosclerotic plaque, fatty deposits, adipose tissues, atherosclerotic cholesterol buildup, fibrous material buildup, arterial stenoses, minerals, high water content tissues, platelets, cellular debris, wastes and other occlusive materials.

“Transverse” as used herein refers to a vibration of a probe not parallel to a longitudinal axis of the probe. A “transverse wave” as used herein is a wave propagated along the probe in which a direction of a disturbance at a plurality of points of a medium is not parallel to a wave vector.

“Vasculature” as used herein refers to the entire circulatory system for the blood supply including the venous system, the arterial system and the associated vessels, arteries, veins, capillaries, blood, and the heart. The arterial system is the means by which blood with oxygen and nutrients is transported to tissues. The venous system is the means by which blood with carbon dioxide and metabolic by-products is transported for excretion.

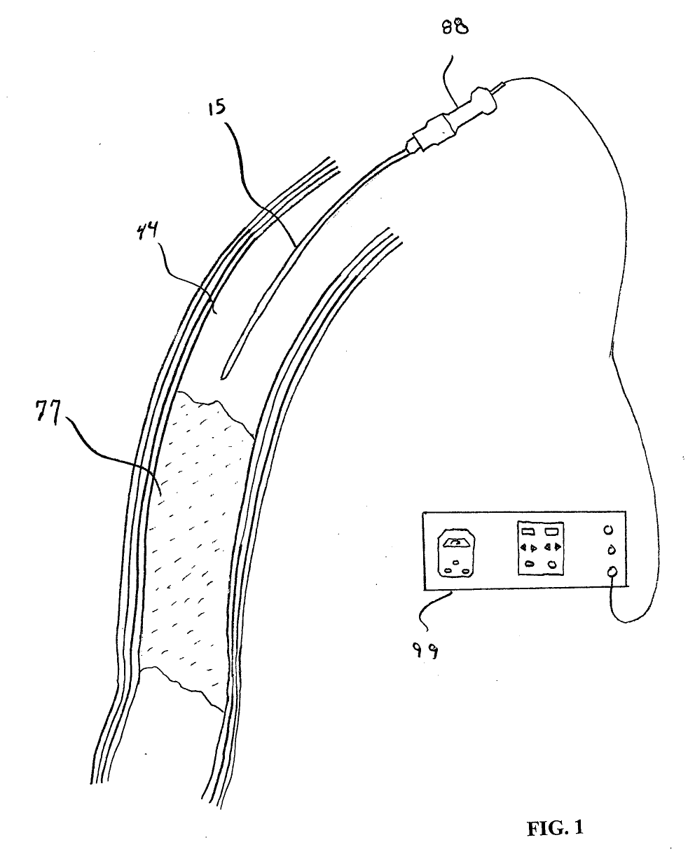

An ultrasonic probe of an ultrasonic medical device of the present invention capable of ablating a chronic total occlusion is illustrated generally at 15 in FIG. 1. FIG. 1 shows the ultrasonic probe inserted into a vasculature 44 and adjacent to a chronic total occlusion 77. A flexibility of the ultrasonic probe 15 allows the ultrasonic probe to be bent, deflected and flexed through the vasculature 44 without compromising the integrity of the vasculature 44 or the ultrasonic probe 15.

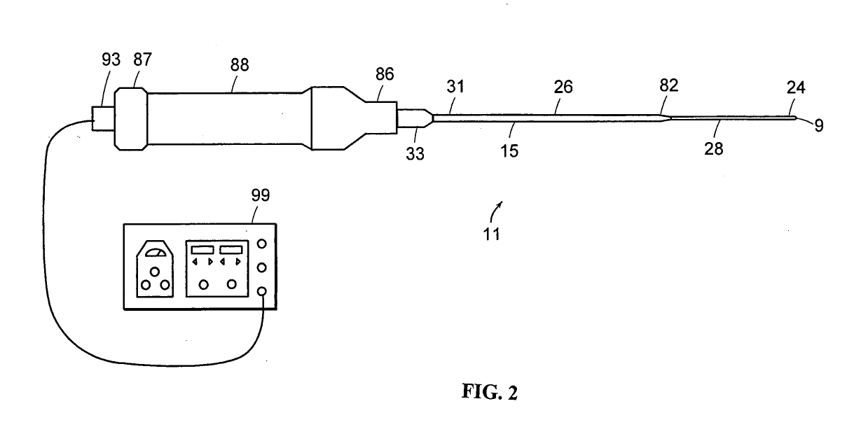

FIG. 2 shows an ultrasonic medical device 11 capable of treating the chronic total occlusion 77 to prevent the chronic total occlusion 77 from obstructing the vasculature 44. The ultrasonic medical device 11 includes an ultrasonic probe 15 which is coupled to an ultrasonic energy source or generator 99 for the production of an ultrasonic energy. A handle, 88, comprising a proximal end 87 and a distal end 86, surrounds a transducer within the handle 88. The transducer, having a proximal end engaging the ultrasonic energy source 99 and a distal end coupled to a proximal end 31 of the ultrasonic probe 15, transmits the ultrasonic energy to the ultrasonic probe 15. A connector 93 and a connecting wire 98 engage the ultrasonic energy source 99 to the transducer. The ultrasonic probe 15 includes the proximal end 31, a distal end 24 that ends in a probe tip 9 and a longitudinal axis between the proximal end 31 and the distal end 24. In an embodiment of the present invention shown in FIG. 2, a diameter of the ultrasonic probe decreases from a first defined interval 26 to a second defined interval 28 along the longitudinal axis of the ultrasonic probe 15 over a transition 82. A coupling 33 that engages the proximal end 31 of the ultrasonic probe 15 to the transducer within the handle 88 is illustrated generally in FIG. 2. In a preferred embodiment of the present invention, the coupling is a quick attachment-detachment system. An ultrasonic medical device with a rapid attachment and detachment means is described in the Assignee's U.S. Pat. No. 6,695,782 and Assignee's co-pending patent applications U.S. Ser. No. 10/268,487 and U.S. Ser. No. 10/268,843, which further describe the quick attachment-detachment system and the entirety of these patents and patent applications are hereby incorporated herein by reference.

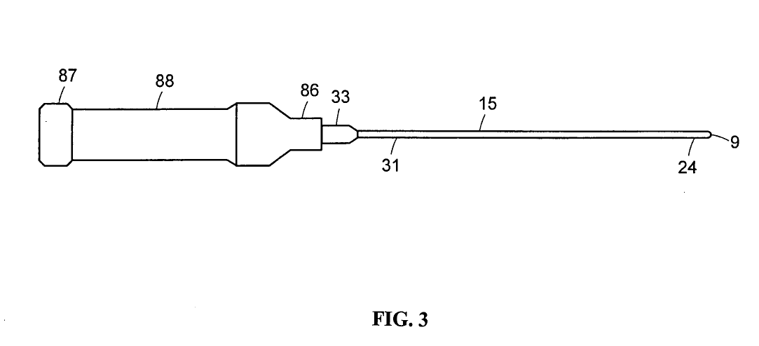

FIG. 3 shows an embodiment of the ultrasonic probe 15 of the present invention where the diameter of the ultrasonic probe 15 is approximately uniform from the proximal end 31 of the ultrasonic probe 15 to the distal end 24 of the ultrasonic probe 15.

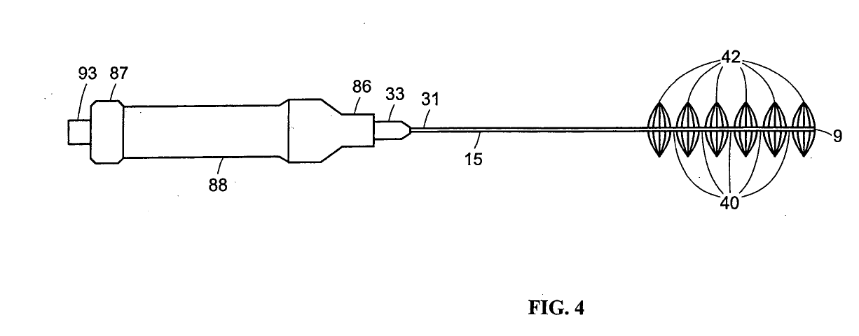

FIG. 4 shows a side plan view of an ultrasonic probe 15 of the present invention showing a plurality of transverse nodes 40 and a plurality of transverse anti-nodes 42 along a portion of a longitudinal axis of the ultrasonic probe 15.

In a preferred embodiment of the present invention, the ultrasonic probe 15 is a wire. In an embodiment of the present invention, the ultrasonic probe 15 is elongated. In an embodiment of the present invention, the diameter of the ultrasonic probe 15 changes at greater than two defined intervals. In an embodiment of the present invention, the transitions 82 of the ultrasonic probe 15 are tapered to gradually change the diameter from the proximal end 31 to the distal end 24 along the longitudinal axis of the ultrasonic probe 15. In another embodiment of the present invention, the transitions 82 of the ultrasonic probe 15 are stepwise to change the diameter from the proximal end 31 to the distal end 24 along the longitudinal axis of the ultrasonic probe 15. Those skilled in the art will recognize there can be any number of defined intervals and transitions, and the transitions can be of any shape known in the art and be within the spirit and scope of the present invention.

In an embodiment of the present invention, the gradual change of the diameter from the proximal end 31 to the distal end 24 occurs over the at least one transition 82, with each transition 82 having an approximately equal length. In another embodiment of the present invention, the gradual change of the diameter from the proximal end 31 to the distal end 24 occurs over a plurality of transitions 82 with each transition 82 having a varying length. The transition 82 refers to a section where the diameter varies from a first diameter to a second diameter.

In a preferred embodiment of the present invention, the ultrasonic probe 15 has a small diameter. In a preferred embodiment of the present invention, the cross section of the ultrasonic probe 15 is approximately circular. In another embodiment, the cross section of at least a portion of the ultrasonic probe 15 is non-circular. The ultrasonic probe 15 comprising a wire having a non-circular cross section at the distal end can navigate through the vasculature. The ultrasonic probe 15 comprising a flat wire is steerable in the vasculature. In other embodiments of the present invention, a shape of the cross section of the ultrasonic probe 15 includes, but is not limited to, square, trapezoidal, oval, triangular, circular with a flat spot and similar cross sections. Those skilled in the art will recognize that other cross sectional geometric configurations known in the art would be within the spirit and scope of the present invention.

In an embodiment of the present invention, the diameter of the distal end 24 of the ultrasonic probe 15 is about 0.004 inches. In another embodiment of the present invention, the diameter of the distal end 24 of the ultrasonic probe 15 is about 0.015 inches. In other embodiments of the present invention, the diameter of the distal end 24 of the ultrasonic probe 15 varies between about 0.003 inches and about 0.025 inches. Those skilled in the art will recognize an ultrasonic probe 15 can have a diameter at the distal end 24 smaller than about 0.003 inches, larger than about 0.025 inches, and between about 0.003 inches and about 0.025 inches and be within the spirit and scope of the present invention.

In an embodiment of the present invention, the diameter of the proximal end 31 of the ultrasonic probe 15 is about 0.012 inches. In another embodiment of the present invention, the diameter of the proximal end 31 of the ultrasonic probe 15 is about 0.025 inches. In other embodiments of the present invention, the diameter of the proximal end 31 of the ultrasonic probe 15 varies between about 0.003 inches and about 0.025 inches. Those skilled in the art will recognize the ultrasonic probe 15 can have a diameter at the proximal end 31 smaller than about 0.003 inches, larger than about 0.025 inches, and between about 0.003 inches and about 0.025 inches and be within the spirit and scope of the present invention.

The probe tip 9 can be any shape including, but not limited to, rounded, bent, a ball or larger shapes. In a preferred embodiment of the present invention, the probe tip 9 is smooth to prevent damage to the vasculature 44. In one embodiment of the present invention, the ultrasonic energy source 99 is a physical part of the ultrasonic medical device 11. In another embodiment of the present invention, the ultrasonic energy source 99 is not an integral part of the ultrasonic medical device 11. The ultrasonic probe 15 is used to ablate the chronic total occlusion 77 and may be disposed of after use. In a preferred embodiment of the present invention, the ultrasonic probe 15 is for a single use and on a single patient. In a preferred embodiment of the present invention, the ultrasonic probe 15 is disposable. In another embodiment of the present invention, the ultrasonic probe 15 can be used multiple times.

The ultrasonic probe 15 is designed, constructed and comprised of a material to not dampen the transverse ultrasonic vibration, and thereby supports a transverse vibration when flexed. In a preferred embodiment of the present invention, the ultrasonic probe 15 comprises titanium or a titanium alloy. Titanium is a strong, flexible, low density, low radiopacity and easily fabricated metal that is used as a structural material. Titanium and its alloys have excellent corrosion resistance in many environments and have good elevated temperature properties. In a preferred embodiment of the present invention, the ultrasonic probe 15 comprises titanium alloy Ti-6Al-4V. The elements comprising Ti-6Al-4V and the representative elemental weight percentages of Ti-6Al-4V are titanium (about 90%), aluminum (about 6%), vanadium (about 4%), iron (maximum about 0.25%) and oxygen (maximum about 0.2%). In another embodiment of the present invention, the ultrasonic probe 15 comprises stainless steel. In another embodiment of the present invention, the ultrasonic probe 15 comprises an alloy of stainless steel. In another embodiment of the present invention, the ultrasonic probe 15 comprises aluminum. In another embodiment of the present invention, the ultrasonic probe 15 comprises an alloy of aluminum. In another embodiment of the present invention, the ultrasonic probe 15 comprises a combination of titanium and stainless steel.

In another embodiment of the present invention, the ultrasonic probe 15 comprises a super-elastic alloy. Even when bent or stretched, the super-elastic alloy returns to its original shape when the stress is removed. The ultrasonic probe 15 may contain super-elastic alloys known in the art including, but not limited to, nickel-titanium super-elastic alloys and Nitinol. Nitinol is a family of intermetallic materials, which contain a nearly equal mixture of nickel and titanium. Other elements can be added to adjust or tune the material properties. Nitinol is less stiff than titanium and is maneuverable in the vasculature. Nitonol has shape memory and super-elastic characteristics. The shape memory effect describes the process of restoring the original shape of a plastically deformed sample by heating it. This is a result of a crystalline phase change known as thermoelastic martensitic transformation. Below the transformation temperature, Nitinol is martensitic. Nitinol's excellent corrosion resistance, biocompatibility, and unique mechanical properties make it well suited for medical devices. Those skilled in the art will recognize that the ultrasonic probe can be comprised of many other materials known in the art and be within the spirit and scope of the present invention.

The physical properties (i.e., length, cross sectional shape, dimensions, etc.) and material properties (i.e., yield strength, modulus, etc.) of the ultrasonic probe 15 are selected for operation of the ultrasonic probe 15 in the transverse mode. The length of the ultrasonic probe 15 of the present invention is chosen to be resonant in a transverse mode. In an embodiment of the present invention, the ultrasonic probe 15 is between about 30 centimeters and about 300 centimeters in length. Those skilled in the art will recognize an ultrasonic probe can have a length shorter than about 30 centimeters, a length longer than about 300 centimeters and a length between about 30 centimeters and about 300 centimeters and be within the spirit and scope of the present invention.

The handle 88 surrounds the transducer located between the proximal end 31 of the ultrasonic probe 15 and the connector 93. In a preferred embodiment of the present invention, the transducer includes, but is not limited to, a horn, an electrode, an insulator, a backnut, a washer, a piezo microphone, and a piezo drive. The transducer converts electrical energy provided by the ultrasonic energy source 99 to mechanical energy and sets the operating frequency of the ultrasonic medical device 11. The transducer is capable of engaging the ultrasonic probe 15 at the proximal end 31 with sufficient restraint to form an acoustical mass that can propagate the ultrasonic energy provided by the ultrasonic energy source 99.

In a preferred embodiment of the present invention, the ultrasonic probe 15 of the present invention is used to treat a chronic total occlusion 77 in the arterial system. The ultrasonic probe 15 of the present invention is used to treat chronic total occlusions 77 located in arteries including, but not limited to, the femoral artery, the tibial artery and the coronary arteries of the heart. In another embodiment of the present invention, the ultrasonic probe 15 of the present invention is used to treat a chronic total occlusion 77 in the venous system.

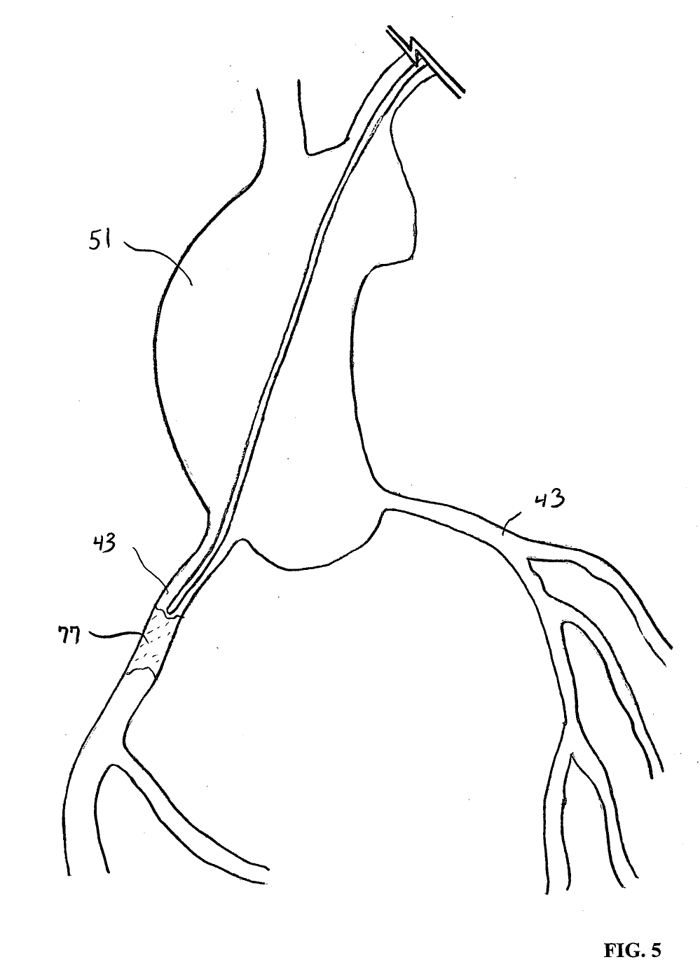

FIG. 5 shows the ultrasonic probe 15 adjacent to the chronic total occlusion 77 in a coronary artery 43 of a heart. In the embodiment of the present invention shown in FIG. 5, the ultrasonic probe is moved through an aorta 51 of the heart and placed adjacent to the chronic total occlusion 77. Subsequent discussion of the treatment of the chronic total occlusion 77 will focus on the chronic total occlusion 77 in the coronary artery 43 of the heart, but the discussion is applicable to treatment of chronic total occlusions throughout the body.

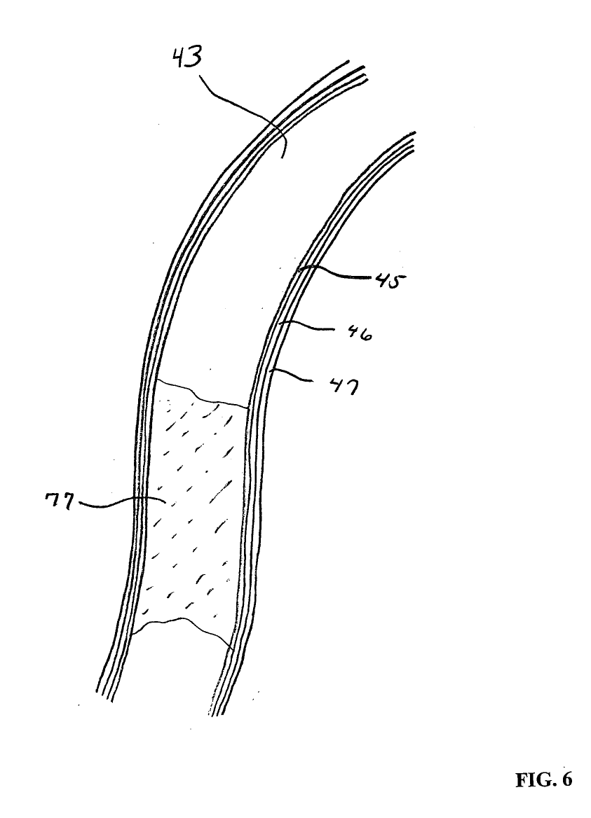

FIG. 6 shows an enlarged view of the chronic total occlusion 77 in the coronary artery 43. The artery comprises a plurality of layers including the intimal layer 45, the medial layer 46 and the adventitial layer 47. Moving outward in a radial direction, the intimal layer 45 includes a thin lining called the endothelium which is surround by the subendothelial layer. The internal elastic lamina surrounds the subendothelial layer in the intimal layer 45. The medial layer 46 surrounds the intimal layer 45 and is comprised mostly of smooth muscle cells. The adventitial layer 47 surrounds the medial layer and is the outermost layer of the artery.

In the embodiment of the present invention shown in FIG. 5 and FIG. 6, the chronic total occlusion 77 blocks the entire cross section of the coronary artery 43. Chronic total occlusions 77 are comprised of many materials which build up along the inner diameter of the coronary artery 43 and build inward to substantially reduce the cross section of the coronary artery 43. As the chronic total occlusions 77 builds, the blood flow through the artery or vein decreases. Pathologically, the major component of the chronic total occlusion 77 is fibrocalcific plaque.

The chronic total occlusion 77 blocks the flow of blood through the coronary artery 43. Like all organs and tissues in the body, the heart muscle needs oxygen rich blood to survive. Blood is supplied to the coronary arteries 43 by the aorta 51, the main blood supplier to the body. The coronary arteries 43 subsequently branch off into smaller arteries, which supply oxygen rich blood to the entire heart muscle. The right coronary artery supplies blood to the right side of the heart, which subsequently pumps blood to the lungs. The left coronary artery, which branches into the left anterior descending artery and the circumflex artery, supplies blood to the left side of the heart, which subsequently pumps blood to the rest of the body. By blocking the flow of blood through the coronary artery 43, the chronic total occlusion 77 poses a life threatening condition that should be treated in a quick timeframe. Care must be taken to not pass the particulate downstream of the chronic total occlusion 77 to prevent further complications, including formation of another occlusion, downstream of the chronic total occlusion 77.

The ultrasonic probe 15 is moved adjacent to the chronic total occlusion 77 in the coronary artery 43. Those skilled in the art will recognize that numerous methods of inserting the ultrasonic probe 15 adjacent to the chronic total occlusion 77 are known in the art and are within the spirit and scope of the present invention. A conventional method of placing the ultrasonic probe 15 adjacent to the chronic total occlusion 77 involves using a vascular introducer. The vascular introducer is inserted into a femoral artery in the groin to create an insertion point in the femoral artery. A vascular introducer for use with an ultrasonic probe is described in Assignee's co-pending patent application U.S. Ser. No. 10/080,787, and the entirety of this application is hereby incorporated herein by reference.

A guidewire is inserted into the femoral artery through the vascular introducer and moved up to an over the aortic arch. In an embodiment of the present invention, the guidewire is a standard guidewire conventionally known in the art. In another embodiment of the present invention, the guidewire is the ultrasonic probe 15 of the present invention. A guide catheter is placed over the guidewire and moved toward the heart. The guidewire is moved into the coronary artery 43 and adjacent to the chronic total occlusion 77. The standard guidewire is unable to be used to cross the chronic total occlusion 77.

With the guidewire located adjacent to the chronic total occlusion 77, a microcatheter is introduced over the guidewire and advanced in the vasculature toward the coronary artery 43 until the outer diameter of the microcatheter is approximately equal to the inner diameter of the vasculature. With the microcatheter in place, the guidewire is removed and the ultrasonic probe 15 is inserted into the vasculature introducer and moved through the lumen of the microcatheter to place the probe tip 9 at the distal end of the microcatheter. The ultrasonic probe 15 has a stiffness that gives the ultrasonic probe 15 a flexibility allowing the ultrasonic probe to be deflected, flexed and bent through the tortuous paths of the vasculature to the coronary artery 43. The ultrasonic probe 15 has a low profile to minimize the loss of blood flow.

A portion of the longitudinal axis of the ultrasonic probe 15 is exposed as the ultrasonic probe 15 is placed in communication with the chronic total occlusion 77. In one embodiment of the present invention, the ultrasonic probe 15 is pushed past the distal end of the microcatheter to expose a portion of the longitudinal axis of the ultrasonic probe 15. In another embodiment of the present invention, the microcatheter is pulled back to expose a portion of the longitudinal axis of the ultrasonic probe 15.

With the ultrasonic probe 15 in communication with the chronic total occlusion 77, the ultrasonic energy source 99 is activated to provide a low power electric signal of between about 2 watts to about 15 watts to the transducer that is located within the handle 88. The transducer converts electrical energy provided by the ultrasonic energy source 99 to mechanical energy. The operating frequency of the ultrasonic medical device 11 is set by the transducer and the ultrasonic energy source 99 finds the resonant frequency of the transducer through a Phase Lock Loop. By an appropriately oriented and driven cylindrical array of piezoelectric crystals of the transducer, the horn creates a longitudinal wave along at least a portion of the longitudinal axis of the ultrasonic probe 15. The longitudinal wave is converted to a transverse wave along at least a portion of the longitudinal axis of the ultrasonic probe 15 through a nonlinear dynamic buckling of the ultrasonic probe 15.

As the transverse wave is transmitted along the longitudinal axis of the ultrasonic probe 15, a transverse ultrasonic vibration is created along the longitudinal axis of the ultrasonic probe 15. The ultrasonic probe 15 is vibrated in a transverse mode of vibration. The transverse mode of vibration of the ultrasonic probe 15 differs from an axial (or longitudinal) mode of vibration disclosed in the prior art. The transverse ultrasonic vibrations along the longitudinal axis of the ultrasonic probe 15 create a plurality of transverse nodes 40 and a plurality of transverse anti-nodes 42 along a portion of the longitudinal axis of the ultrasonic probe 15.

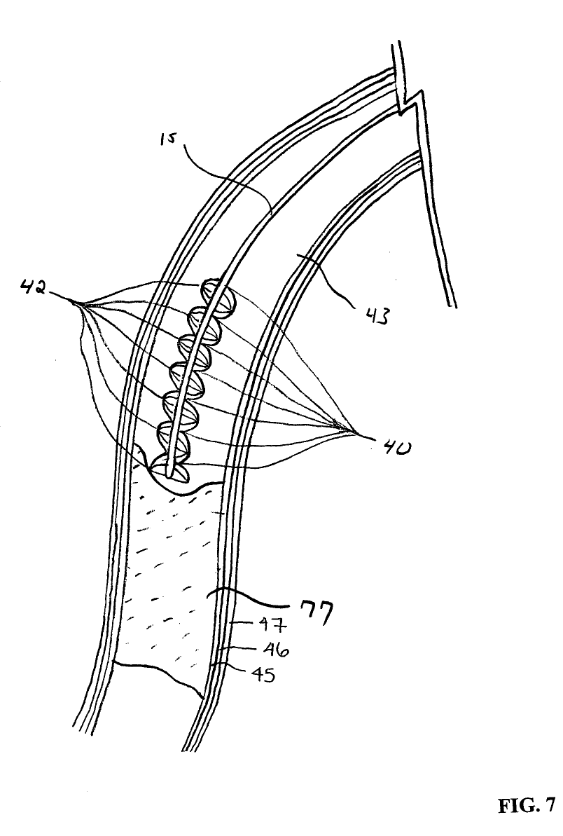

FIG. 7 shows the ultrasonic probe 15 of the present invention having a plurality of transverse nodes 40 and a plurality of transverse anti-nodes 42 along a portion of the longitudinal axis of the ultrasonic probe 15 and in communication with the chronic total occlusion 77. The transverse nodes 40 are areas of minimum energy and minimum vibration. The transverse anti-nodes 42, or areas of maximum energy and maximum vibration, occur at repeating intervals along the portion of the longitudinal axis of the ultrasonic probe 15. The number of transverse nodes 40 and transverse anti-nodes 42, and the spacing of the transverse nodes 40 and transverse anti-nodes 42 of the ultrasonic probe 15 depend on the frequency of energy produced by the ultrasonic energy source 99. The separation of the transverse nodes 40 and transverse anti-nodes 42 is a function of the frequency, and can be affected by tuning the ultrasonic probe 15. In a properly tuned ultrasonic probe 15, the transverse anti-nodes 42 will be found at a position one-half of the distance between the transverse nodes 40 located adjacent to each side of the transverse anti-nodes 42.

The transverse wave is transmitted along the longitudinal axis of the ultrasonic probe 15 and the interaction of the surface of the ultrasonic probe 15 with the medium surrounding the ultrasonic probe 15 creates an acoustic wave in the surrounding medium. As the transverse wave is transmitted along the longitudinal axis of the ultrasonic probe 15, the ultrasonic probe 15 vibrates transversely. The transverse motion of the ultrasonic probe 15 produces cavitation in the medium surrounding the ultrasonic probe 15 to ablate the chronic total occlusion 77. Cavitation is a process in which small voids are formed in a surrounding medium through the rapid motion of the ultrasonic probe 15 and the voids are subsequently forced to compress. The compression of the voids creates a wave of acoustic energy which acts to dissolve the matrix binding the chronic total occlusion 77, while having no damaging effects on healthy tissue.

As the ultrasonic probe is advanced in the coronary artery 43, the acoustic pressure waves of the transverse ultrasonic vibration resolve the chronic total occlusion 77 into a particulate having a size on the order of red blood cells (approximately 5 microns in diameter). The size of the particulate is such that the particulate is easily discharged from the body through conventional methods or simply dissolves into the blood stream. A conventional method of discharging the particulate from the body includes transferring the particulate through the blood stream to the kidney where the particulate is excreted as bodily waste. By resolving the chronic total occlusion 77 to a particulate, the particulate will travel with the blood to the heart and ultimately to the arteries of the lungs without any risk of obstructing the arteries and causing a pulmonary embolism or a pulmonary infarction.

The transverse ultrasonic vibration of the ultrasonic probe 15 results in a portion of the longitudinal axis of the ultrasonic probe 15 vibrated in a direction not parallel to the longitudinal axis of the ultrasonic probe 15. The transverse vibration results in movement of the longitudinal axis of the ultrasonic probe 15 in a direction approximately perpendicular to the longitudinal axis of the ultrasonic probe 15. Transversely vibrating ultrasonic probes for biological material ablation are described in the Assignee's U.S. Pat. No. 6,551,337; U.S. Pat. No. 6,652,547; U.S. Pat. No. 6,660,013; and U.S. Pat. No. 6,695,781, which further describe the design parameters for such an ultrasonic probe and its use in ultrasonic devices for ablation, and the entirety of these patents are hereby incorporated herein by reference.

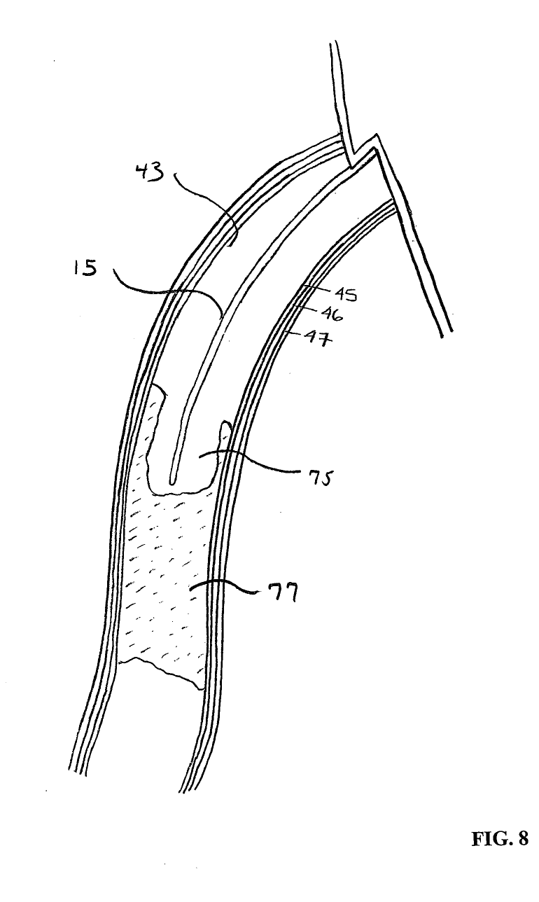

FIG. 8 shows the ultrasonic probe 15 advanced over a length of the chronic total occlusion 77, creating a channel 75 through the chronic total occlusion 77. The acoustic pressure in front of and circumferentially around the ultrasonic probe 15 ablates the chronic total occlusion 77 over a portion of the longitudinal axis of the ultrasonic probe 15, thereby creating the channel 75 through the chronic total occlusion 77. The method of ablating the chronic total occlusion 77 is non-forced, non-heat generating and non-physical, relying on the acoustic pressure surrounding the ultrasonic probe 15.

The ultrasonic probe 15 can be passed through the length of the chronic total occlusion 77 to create the channel 75 through the entire length of the chronic total occlusion 77. After the channel 75 is created the vessel is patent, but it may not be opened sufficiently for normal flow to exist. The ultrasonic probe 15 can then be moved along the chronic total occlusion 77 to ablate additional occlusive material. For example, the ultrasonic probe 15 can be swept, rotated, twisted, moved back and forth, deflected, flexed and bent along the chronic total occlusion 77. Those skilled in the art will recognize that the many ways to move the ultrasonic probe in communication with the chronic total occlusion known in the art are within the spirit and scope of the present invention.

Alternatively, the chronic total occlusion 77 can be treated with a vascular intervention device (i.e., an ancillary balloon and/or stent). The coupling 33 that engages the proximal end 31 of the ultrasonic probe 15 to the transducer within the handle 88 is detached from the ultrasonic probe 15, freeing the proximal end 31 of the ultrasonic probe 15. The proximal end 31 of the ultrasonic probe 15 has a small diameter that allows a vascular intervention device to be placed over the proximal end 31 of the ultrasonic probe and moved along the longitudinal axis of the ultrasonic probe 15 while the ultrasonic probe 15 remains within a vasculature 44. Any vascular intervention device known in the art can be passed over the ultrasonic probe 15 including, but not limited to, a catheter, balloon catheter, inflation mechanism, a PTCA balloon, a stent, a stent delivery system, a graft, a stent graft, a drug eluding stent, vascular introducer, lumen, probe, and other similar devices known in the art. An apparatus and method for an ultrasonic medical device having a probe with a small proximal end for permitting over the probe transfers of vascular intervention devices is described in Assignee's co-pending patent application U.S. Ser. No. 10/959,703, and the entirety of this application is hereby incorporated herein by reference.

Prior art devices use physical methods to pass through the chronic total occlusion 77. Physical force applied to a device such as the ultrasonic probe 15 of the present invention interferes with the acoustic properties of the ultrasonic probe 15. By compressing or loading forces onto the ultrasonic probe 15, the frequency of the ultrasonic probe 15 changes, causing the frequency to fall out of the desired frequency spectrum where the chronic total occlusion 77 can be ablated.

As a consequence of the transverse ultrasonic vibration of the ultrasonic probe 15, the chronic total occlusion destroying effects of the ultrasonic medical device 11 are not limited to those regions of the ultrasonic probe 15 that may come into contact with the chronic total occlusion 77. Rather, as a section of the longitudinal axis of the ultrasonic probe 15 is positioned in proximity to the chronic total occlusion 77, the chronic total occlusion 77 is removed in all areas adjacent to the plurality of energetic transverse anti-nodes 42 that are produced along the portion of the length of the longitudinal axis of the ultrasonic probe 15, typically in a region having a radius of up to about 6 mm around the ultrasonic probe 15.

A novel feature of the present invention is the ability to utilize ultrasonic probes 15 of extremely small diameter compared to prior art probes, without loss of efficiency, because the chronic total occlusion fragmentation process is not dependent on the area of the probe tip 9. Highly flexible ultrasonic probes 15 can therefore be designed for facile insertion into chronic total occlusion areas or narrow interstices that contain the chronic total occlusion 77. Another advantage provided by the present invention is the ability to rapidly move the chronic total occlusion 77 from large areas within cylindrical or tubular surfaces.

The number of transverse nodes 40 and transverse anti-nodes 42 occurring along the longitudinal axis of the ultrasonic probe 15 is modulated by changing the frequency of energy supplied by the ultrasonic energy source 99. The exact frequency, however, is not critical and the ultrasonic energy source 99 run at, for example, about 20 kHz is sufficient to create an effective number of chronic total occlusion destroying transverse anti-nodes 42 along the longitudinal axis of the ultrasonic probe 15. The low frequency requirement of the present invention is a further advantage in that the low frequency requirement leads to less damage to healthy tissue. Those skilled in the art understand it is possible to adjust the dimensions of the ultrasonic probe 15, including diameter, length and distance to the ultrasonic energy source 99, in order to affect the number and spacing of the transverse nodes 40 and transverse anti-nodes 42 along a portion of the longitudinal axis of the ultrasonic probe 15.

The present invention allows the use of ultrasonic energy to be applied to the chronic total occlusion selectively, because the ultrasonic probe 15 conducts energy across a frequency range from about 10 kHz through about 100 kHz. The amount of ultrasonic energy to be applied to a particular treatment site is a function of the amplitude and frequency of vibration of the ultrasonic probe 15. In general, the amplitude or throw rate of the energy is in the range of about 25 microns to about 250 microns, and the frequency in the range of about 10 kHz to about 100 kHz. In a preferred embodiment of the present invention, the frequency of ultrasonic energy is from about 20 kHz to about 40 kHz.

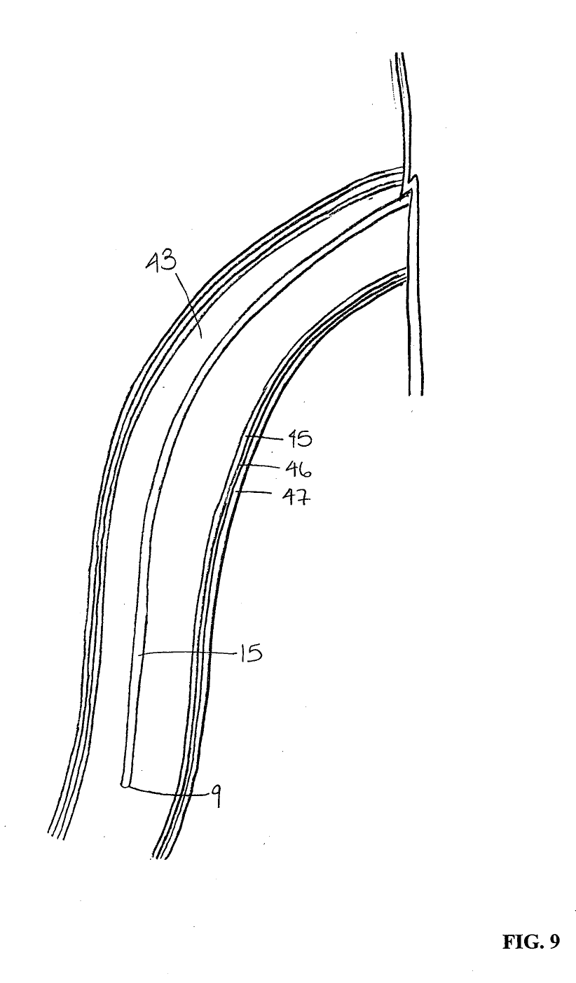

FIG. 9 shows the ultrasonic probe 15 moved through the coronary artery 43 with the chronic total occlusion 77 ablated. In a preferred embodiment of the present invention, the ultrasonic probe 15 is designed to totally resolve the chronic total occlusion 77 as shown in FIG. 9. In another embodiment of the present invention, the chronic total occlusion 77 is partially resolved.

The present invention also is a method of ablating the chronic total occlusion 77 in the vasculature 44 of the body. Access to the vasculature 44 is gained by creating an insertion point in the vasculature 44 using a device such as a vascular introducer. The ultrasonic probe 15 having a proximal end 31, a distal end 24 terminating in the probe tip 9 and a longitudinal axis between the proximal end and the distal end 24 is inserted through the insertion point of the vasculature 44 and moved through the vasculature 44 and placed in communication with the chronic total occlusion 77. A stiffness of the ultrasonic probe 15 of the ultrasonic medical device 11 gives the ultrasonic probe 15 a flexibility allowing the ultrasonic probe 15 to be deflected, flexed and bent through the tortuous paths of the vasculature 44, including the coronary artery 43. The ultrasonic energy source 99 engaged to the ultrasonic probe 15 is activated to produce an electric signal to drive the transducer of the ultrasonic medical device 11 to produce a transverse vibration of the ultrasonic probe 15. The transverse ultrasonic vibration of the ultrasonic probe 15 produces cavitation in a medium surrounding a portion of the length of the longitudinal axis of the ultrasonic probe 15 to ablate the chronic total occlusion 77.

The present invention also provides a method of ablating a chronic total occlusion comprising: providing an ultrasonic medical device comprising an ultrasonic probe having a proximal end, a distal end and a longitudinal axis therebetween; inserting the ultrasonic probe into a vasculature; moving the ultrasonic probe adjacent to the chronic total occlusion; activating an ultrasonic energy source engaged to the ultrasonic probe to generate a transverse ultrasonic vibration along at least a portion of the longitudinal axis of the ultrasonic probe, and placing the ultrasonic probe in communication with the chronic total occlusion; wherein the transverse ultrasonic vibration of the ultrasonic probe creates an acoustic pressure surrounding the ultrasonic probe to ablate the chronic total occlusion and create a channel through the total chronic occlusion.

The present invention also provides a method of removing a chronic total occlusion in a vasculature of a body comprising: providing an ultrasonic medical device comprising an ultrasonic probe having a proximal end, a distal end terminating in a probe tip, and a longitudinal axis between the proximal end and the distal end; inserting the ultrasonic probe in the vasculature; moving the ultrasonic probe adjacent to the chronic total occlusion; activating an ultrasonic energy source engaged to the ultrasonic probe to produce an electric signal that drives a transducer of the ultrasonic medical device to produce a transverse ultrasonic vibration of the ultrasonic probe; advancing the ultrasonic probe through the chronic total occlusion, wherein the transverse ultrasonic vibration produces cavitation in a medium surrounding the ultrasonic probe to ablate the chronic total occlusion along a portion of the longitudinal axis of the ultrasonic probe.

In an alternative embodiment of the present invention, the ultrasonic probe 15 is vibrated in a torsional mode. In the torsional mode of vibration, a portion of the longitudinal axis of the ultrasonic probe 15 comprises a radially asymmetric cross section and the length of the ultrasonic probe 15 is chosen to be resonant in the torsional mode. In the torsional mode of vibration, a transducer transmits ultrasonic energy received from the ultrasonic energy source 99 to the ultrasonic probe 15, causing the ultrasonic probe 15 to vibrate torsionally. The ultrasonic energy source 99 produces the electrical energy that is used to produce a torsional vibration along the longitudinal axis of the ultrasonic probe 15. The torsional vibration is a torsional oscillation whereby equally spaced points along the longitudinal axis of the ultrasonic probe 15 including the probe tip 9 vibrate back and forth in a short arc about the longitudinal axis of the ultrasonic probe 15. A section proximal to each of a plurality of torsional nodes and a section distal to each of the plurality of torsional nodes are vibrated out of phase, with the proximal section vibrated in a clockwise direction and the distal section vibrated in a counterclockwise direction, or vice versa. The torsional vibration results in an ultrasonic energy transfer to the biological material with minimal loss of ultrasonic energy that could limit the effectiveness of the ultrasonic medical device 11. The torsional vibration produces a rotation and a counterrotation along the longitudinal axis of the ultrasonic probe 15 that creates the plurality of torsional nodes and a plurality of torsional anti-nodes along a portion of the longitudinal axis of the ultrasonic probe 15 resulting in cavitation along the portion of the longitudinal axis of the ultrasonic probe 15 comprising the radially asymmetric cross section in a medium surrounding the ultrasonic probe 15 that ablates the biological material. An apparatus and method for an ultrasonic medical device operating in a torsional mode is described in Assignee's co-pending patent application U.S. Ser. No. 10/774,985, and the entirety of this application is hereby incorporated herein by reference.

In another embodiment of the present invention, the ultrasonic probe 15 is vibrated in a torsional mode and a transverse mode. A transducer transmits ultrasonic energy from the ultrasonic energy source 99 to the ultrasonic probe 15, creating a torsional vibration of the ultrasonic probe 15. The torsional vibration induces a transverse vibration along an active area of the ultrasonic probe 15, creating a plurality of nodes and a plurality of anti-nodes along the active area that result in cavitation in a medium surrounding the ultrasonic probe 15. The active area of the ultrasonic probe 15 undergoes both the torsional vibration and the transverse vibration.

Depending upon physical properties (i.e., length, diameter, etc.) and material properties (i.e., yield strength, modulus, etc.) of the ultrasonic probe 15, the transverse vibration is excited by the torsional vibration. Coupling of the torsional mode of vibration and the transverse mode of vibration is possible because of common shear components for the elastic forces. The transverse vibration is induced when the frequency of the transducer is close to a transverse resonant frequency of the ultrasonic probe 15. The combination of the torsional mode of vibration and the transverse mode of vibration is possible because for each torsional mode of vibration, there are many close transverse modes of vibration. By applying tension on the ultrasonic probe 15, for example by bending the ultrasonic probe 15, the transverse vibration is tuned into coincidence with the torsional vibration. The bending causes a shift in frequency due to changes in tension. In the torsional mode of vibration and the transverse mode of vibration, the active area of the ultrasonic probe 15 is vibrated in a direction not parallel to the longitudinal axis of the ultrasonic probe 15 while equally spaced points along the longitudinal axis of the ultrasonic probe 15 vibrate back and forth in a short arc about the longitudinal axis of the ultrasonic probe 15. An apparatus and method for an ultrasonic medical device operating in a transverse mode and a torsional mode is described in Assignee's co-pending patent application U.S. Ser. No. 10/774,898, and the entirety of this application is hereby incorporated herein by reference.

All patents, patent applications, and published references cited herein are hereby incorporated herein by reference in their entirety. While this invention has been particularly shown and described with references to preferred embodiments thereof, it will be understood by those skilled in the art that various changes in form and details may be made therein without departing from the scope of the invention encompassed by the appended claims.

1. An ultrasonic medical device for ablating a chronic total occlusion comprising:
an ultrasonic probe having a proximal end, a distal end and a longitudinal axis therebetween;
an ultrasonic energy source for producing an ultrasonic energy;
a transducer engaged to the ultrasonic energy source for transferring the ultrasonic energy; and
a coupling engaged to the transducer and the proximal end of the ultrasonic probe,
wherein a transverse ultrasonic vibration of the ultrasonic probe maneuvers the ultrasonic probe through the chronic total occlusion.

2. The ultrasonic medical device of claim 1 wherein a diameter of the ultrasonic probe is uniform from the proximal end to the distal end.

3. The ultrasonic medical device of claim 1 wherein a diameter of the ultrasonic probe varies from the proximal end to the distal end.

4. The ultrasonic medical device of claim 1 wherein the ultrasonic probe is a wire.

5. The ultrasonic medical device of claim 1 wherein the transducer creates the transverse ultrasonic vibration along at least a portion of the longitudinal axis of the ultrasonic probe.

6. The ultrasonic medical device of claim 1 wherein the transverse ultrasonic vibration along at least a portion of the longitudinal axis of the ultrasonic probe generates a plurality of transverse anti-nodes along at least a portion of the longitudinal axis of the ultrasonic probe.

7. The ultrasonic medical device of claim 6 wherein the plurality of transverse anti-nodes causes cavitation in a medium surrounding the ultrasonic probe to ablate the chronic total occlusion.

8. The ultrasonic medical device of claim 1 wherein the transverse ultrasonic vibration along at least a portion of the longitudinal axis of the ultrasonic probe generates acoustic energy in a medium surrounding the ultrasonic probe.

9. The ultrasonic medical device of claim 1 wherein the ultrasonic probe is disposable.

10. The ultrasonic medical device of claim 1 wherein the ultrasonic probe is for a single use on a single patient.

11. The ultrasonic medical device of claim 1 wherein the ultrasonic probe comprises a material that allows the ultrasonic probe to be bent, deflected and flexed.

12. The ultrasonic medical device of claim 1 wherein the ultrasonic probe comprises a diameter that enables insertion into a vasculature.

13. The ultrasonic medical device of claim 1 wherein a cross section of the ultrasonic probe is approximately circular.

14. The ultrasonic medical device of claim 1 wherein the ultrasonic probe contains a super-elastic alloy.

15. An ultrasonic medical device for treating a chronic total occlusion comprising:
an ultrasonic probe having a proximal end, a distal end terminating in a probe tip and a longitudinal axis between the proximal end and the distal end, the ultrasonic probe having a flexibility to be flexed through the vasculature and the chronic total occlusion;
a transducer creating a transverse ultrasonic vibration along at least a portion of the longitudinal axis of the ultrasonic probe;
a coupling engaging the proximal end of the ultrasonic probe to a distal end of the transducer; and
an ultrasonic energy source engaged to the transducer that produces an ultrasonic energy,
wherein the transverse ultrasonic vibration produces a plurality of transverse anti-nodes along a portion of the longitudinal axis of the ultrasonic probe to treat the chronic total occlusion.

16. The ultrasonic medical device of claim 15 wherein the ultrasonic probe supports the transverse ultrasonic vibration when flexed.

17. The ultrasonic medical device of claim 15 wherein the ultrasonic probe supporting the transverse ultrasonic vibration interacts with a medium surrounding the ultrasonic probe to create an acoustic wave in the medium.

18. The ultrasonic medical device of claim 15 wherein the ultrasonic energy source delivers ultrasonic energy in a frequency range from about 10 kHz to about 100 kHz.

19. The ultrasonic medical device of claim 15 wherein the ultrasonic energy source provides an electrical energy to the transducer at a resonant frequency of the transducer by finding the resonant frequency of the transducer.

20. The ultrasonic medical device of claim 15 wherein the ultrasonic probe contains a super-elastic alloy.

21. The ultrasonic medical device of claim 15 wherein the ultrasonic probe is disposable.

22. The ultrasonic medical device of claim 15 wherein the ultrasonic probe is for a single use on a single patient.

23. A method of ablating a chronic total occlusion comprising:
providing an ultrasonic medical device comprising an ultrasonic probe having a proximal end, a distal end and a longitudinal axis therebetween;
inserting the ultrasonic probe into a vasculature;
moving the ultrasonic probe adjacent to the chronic total occlusion;
activating an ultrasonic energy source engaged to the ultrasonic probe to generate a transverse ultrasonic vibration along at least a portion of the longitudinal axis of the ultrasonic probe, and
placing the ultrasonic probe in communication with the chronic total occlusion;
wherein the transverse ultrasonic vibration of the ultrasonic probe creates an acoustic pressure surrounding the ultrasonic probe to ablate the chronic total occlusion and create a channel through the total chronic occlusion.

24. The method of claim 23 further comprising sweeping the ultrasonic probe along the chronic total occlusion.

25. The method of claim 23 further comprising moving the ultrasonic back and forth along the chronic total occlusion.

26. The method of claim 23 further comprising rotating the ultrasonic probe along the chronic total occlusion.

27. The method of claim 23 further comprising twisting the ultrasonic probe along the chronic total occlusion.

28. The method of claim 23 wherein the transverse ultrasonic vibration creates a plurality of transverse nodes and a plurality of transverse anti-nodes along a portion of the longitudinal axis of the ultrasonic probe.

29. The method of claim 23 further comprising providing an electrical energy to a transducer at a resonant frequency of the transducer by the ultrasonic energy source determining the resonant frequency of the transducer.

30. The method of claim 23 further comprising delivering ultrasonic energy in a frequency range from about 10 kHz to about 100 kHz by the ultrasonic energy source.

31. The method of claim 23 wherein the ultrasonic probe contains a super-elastic alloy.

32. A method of removing a chronic total occlusion in a vasculature of a body comprising:
providing an ultrasonic medical device comprising an ultrasonic probe having a proximal end, a distal end terminating in a probe tip, and a longitudinal axis between the proximal end and the distal end;
inserting the ultrasonic probe in the vasculature;
moving the ultrasonic probe adjacent to the chronic total occlusion;
activating an ultrasonic energy source engaged to the ultrasonic probe to produce an electric signal that drives a transducer of the ultrasonic medical device to produce a transverse ultrasonic vibration of the ultrasonic probe;
advancing the ultrasonic probe through the chronic total occlusion,
wherein the transverse ultrasonic vibration produces cavitation in a medium surrounding the ultrasonic probe to ablate the chronic total occlusion along a portion of the longitudinal axis of the ultrasonic probe.

33. The method of claim 32 wherein a channel is created through the chronic total occlusion.

34. The method of claim 32 further comprising producing a plurality of transverse anti-nodes along a portion of the longitudinal axis of the ultrasonic probe by the transverse ultrasonic vibration.

35. The method of claim 32 further comprising inserting a vascular introducer in the vasculature to gain access to the vasculature.

36. The method of claim 32 further comprising twisting the ultrasonic probe along the chronic total occlusion.

37. The method of claim 32 further comprising rotating the ultrasonic probe along the chronic total occlusion.

38. The method of claim 32 further comprising sweeping the ultrasonic probe along the chronic total occlusion.

39. The method of claim 32 further comprising moving the ultrasonic back and forth along the chronic total occlusion.

40. The method of claim 32 wherein the ultrasonic probe contains a super-elastic alloy.
